(19) United States
(12) Patent Application Publication
(10) Pub. No.: US 2025/0076871 A1
(43) Pub. Date: Mar. 6, 2025

(54) Digital Engineering Information System

(71) Applicant: Akintunde Famodimu, Garland, TX (US)

(72) Inventor: Akintunde Famodimu, Garland, TX (US)

(21) Appl. No.: 18/823,608

(22) Filed: Sep. 3, 2024

Related U.S. Application Data
(60) Provisional application No. 63/580,636, filed on Sep. 5, 2023.

(51) Int. Cl. G05B 23/02

(52) U.S. Cl. CPC G05B 23/0283; G05B 23/027; G05B 23/0294

(57) ABSTRACT

Described herein is the Digital Information Management System (DIMS) which uses advances in AI and/or machine learning to automate data management. In some embodiments, DIMS offers self-diagnosis in the interest of providing effective, timely maintenance, and continuing operation while systems are down. Embodiments of anti-malware are also described, covering common attack vectors in an Internet of Things sensor system, and bolstered by AI and/or machine learning. Data processing and presentation is further enhanced by AI and/or machine learning, to validate, verify, and extrapolate/interpolate values in a variety of formats. Embodiments of visualization subsystems are also described, which include a variety of analytics and recommendations to further automate and increase the efficiency of data analysis across a wide range of assets and/or phenomena. Notification connects users to DIMS with tailored updates, notifications, predictive maintenance alerts, queries, and other specified information.

### CROSS-REFERENCE TO RELATED APPLICATION

This application claims priority from U.S. Provisional Application No. 63/580,636 filed on Sep. 3, 2023, the entirety of which is hereby fully incorporated by reference herein.

### BACKGROUND

In the 21st century, vast amounts of data processing are critical to every industry. The data revolution has led data to be considered the ‘oil’ of the 21st century, with data being used for planning, maintenance, troubleshooting, research, and more. With revolutions in machine learning and artificial intelligence (AI), data has become even more important, as AI holds the potential for vastly greater data-processing capabilities.

Current systems of data acquisition, processing, and visualization are outdated for numerous reasons. They still involve manual or intermittent data acquisition or management, leading to human error and data input latency issues. They require technical training to interpret, with data not being presented in a manner that is intuitive. Current models are static-rather than dynamic—and fail to utilize advances in machine learning and predictive data interpolation or extrapolation. They cannot diagnose their own performance, automatically schedule maintenance, operate in the absence of data, or sufficiently defend themselves against cyber-attacks. Overall, the capabilities of data acquisition and management will undergo a qualitative change through the introduction of AI technologies.

There is a need for a data management system that runs continuously and flexibly; adapts to user preferences; generates user-configured reports and self-updating analytics that evolve dynamically; seamlessly interfaces with operators and maintainers through a system of customizable notifications and guidance; incorporates self-diagnosis, as well as data security measures and predictive maintenance; incorporates data interpretation; and offers a multifunctional user interface for enhanced operational efficiency and reduced human intervention.

### SUMMARY

The Digital Information Management System (DIMS) is a data management system that comprises five core functions: data acquisition, data transmission, data processing, data presentation, and user notification. Data acquisition includes an array of physical data acquisition units—which may be statically stationed or dynamic data acquisition units positioned on moving vehicles or other moving things—operating in an Internet of Things system, each of which is equipped with the means for acquisition, transmission, and data security. Data is continuously transmitted from the data acquisition units to a central processing server, and finally to operators and maintainers (collectively, users). Data processing organizes, indexes, and converts the data into readable formats for exportation and user comprehension, and may be facilitated by machine learning for further enrichment, validation, or verification. Data presentation includes a visualization subsystem to provide dashboard views of data readings, generated reports, data exportation, data sharing and collaboration, interactive AI search query/display, and self-diagnosis actions. User notifications may be adjusted to cater to user preferences and settings, as well as additional analytics and reporting.

### BRIEF DESCRIPTION OF THE DRAWINGS

The features, embodiments, and advantages of this invention will become clearer and better understood through the following descriptions and accompanying drawings.

FIG. 1 is a system map of the five core functions, with additional sub-functions to achieve each end.

FIG. 2 is a system map of one embodiment of the system, in terms of inputs and outputs.

FIG. 3 is an aerial view of one embodiment of the system, which shows the connections between the core functions in physical space.

### DESCRIPTION

Now referring to the summary, the systems and methods disclosed herein will be discussed, highlighting the principles and concepts of various exemplary embodiments of DIMS.

This disclosure is not limited to the particular embodiments shown and described. The terminology used herein describes only the particular embodiments shown and is not intended to be limiting; the scope of the present disclosure is to only be limited by the appended claims. Elements from separate embodiments may be combined.

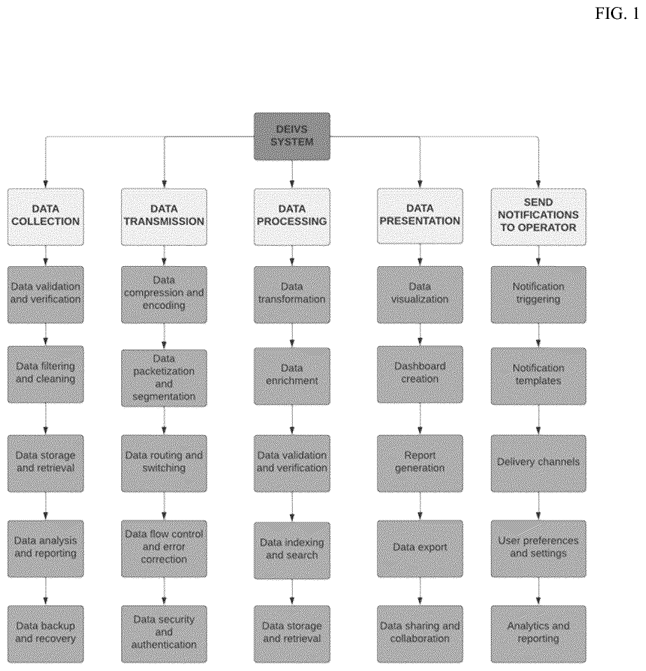

FIG. 1 is a system map of the five core functions of DIMS, with additional sub-functions to achieve each end. Beginning with data acquisition, the type of data acquisition will depend upon the information being monitored. Data acquisition units may measure data including but not limited to: vibrational intensity of buildings, wind speed in buildings and airplanes, ambient temperature on flying airplanes, start and stop events for moving vehicles, detection of fractures or voids at welded seams for underwater vessels and railroad tracks, and equipment usage, performance and maintenance history. For example, in railway transport, railway repairs must be made continuously as trains are constantly moving along the system and railway or other system defects may arise instantly with no warning. Another specific application of DIMS may be for monitoring public utilities such as power, water, and communication systems, as well as other infrastructures where components are distributed across large or difficult-to-access areas. DIMS will alert operators and maintainers after deciding if maintenance is necessary, and will schedule such maintenance without delay. The system may also be used for scientific research or study of physical phenomena within a region, such as with seismology, meteorology, surveying, and other spatial data collection. Alternatively, the system may collect data on human assets and other objects for monitoring and efficiency purposes, or crime prevention, within the constraints of privacy law.

After data is acquired, it is first stored on a local hard drive. Data is transmitted to the central processing subsystem, or backup systems if the system is under attack or otherwise unavailable. Data is continuously validated and verified through AI and/or machine learning, to ensure erroneous readings are not considered. The data is filtered and cleaned in line with user preferences for acceptable thresholds. Lastly, DIMS runs self-diagnosis checks at desired intervals to determine its own functionality and can operate in less-than-ideal parameters while scheduling its own maintenance.

FIG. 1 further comprises the core function of data transmission. Data is aggregated for transmission following its initial acquisition. It may then be subject to further compression, encoding, or encryption. Data is packetized and segmented, and then routed and switched to the appropriate subsystem. Flow control techniques such as buffering, windowing, and congestion avoidance algorithms are in place to prevent data loss and/or corruption. Techniques such as Hamming codes, Reed-Solomon codes, or automatic repeat requests may be used to provide error correction. Data security and authentication is also vital to the system, and may include measures such as secure protocols, user authentication, data integrity checks (such as cryptographic hash functions), firewalls and intrusion detection/prevention systems (IDS/IPS), and physical security measures.

FIG. 1 further comprises the core function of data processing. Data processing converts the raw data from the data acquisition units into readable forms across multiple optimized formats—including but not limited to tabular, free-form, or graphical formats. Data is stored in a central indexed database, where it is validated, verified, and encrypted/decrypted. Data processing further includes machine learning to provide for data validation, verification, and enrichment functions such as signal-to-noise processing, filtering, sorting, secondary calculations (e.g., calculations for the modulus of elasticity, Bernoulli's equation, engine volumetric efficiency, etc.) and reinforcement learning to recognize valid and relevant data.

FIG. 1 further comprises the core function of data presentation through the data visualization subsystem. In some embodiments of the invention, machine learning and/or AI model(s) then analyze data trends to generate custom user reports (e.g., simple scores, signal-to-noise ratio, secondary statistical calculations, trend reporting, etc.), timelines, interpolations/extrapolations, predictions, and assessments of the need for notification. AI and/or machine learning models may include LLM models, graphical databases, or algorithms that are trained on classes of data that the user seeks to study. The visualization subsystem may include dashboard creation, graphical interfaces, user preferences settings for analysis and notification, 3D data visualization, search and query, exportation, sharing, and collaboration functions. Specific advantages of the visualization subsystem can include: alarm threshold values, data acquisition over specified periods of time, estimates on asset lifespan (for both the asset as a whole or any combination of specific components), trend data, and machine learning and/or AI decision-making and recommendations.

FIG. 1 further comprises the core function of data notification. Notifications may be sent to both operators and maintainers. Notification templates and delivery channels may be customized, including through web applications, mobile applications, or other means for notification transmission. Notifications may include predictive maintenance alerts, abnormal readings, general analytics and reporting, at-a-glance dashboard updates, or other user-requested and machine learning and/or AI processed information requests. In aiding with notification, user preferences and settings may be adjusted for the thresholds, types, forms, and frequencies of notification to the user. The notification process may also be interactive, including customized data queries to gather additional information.

It is a present function of the disclosed DIMS to provide for self-diagnosis of its functions without the need for external input. DIMS may run under multiple scenarios that factor in the condition of the system. Self-diagnosis will generate an automatic decision as to which scenario should govern the operation of the system. Self-diagnosis may be initialized with software bootup, through manual input, or at regular intervals during operation. Self-diagnosis may be accomplished by means including but not limited to—abnormal data signature reading, diagnostic pattern warning signs, patterns and outliers, alarm conditions, distress signals, and the like. Embodiments of these scenarios will be discussed below. Ideas from one embodiment may be used in any combination with ideas presented in others with no requirement for exclusivity.

In the Happy Path Scenario, the system is fully functioning without any errors. DIMS runs a check on all software and hardware functions to ensure they are collecting, sending, processing, presenting, and notifying of valid data. Under this scenario, the operator may access information on collected data within the visualization subsystem as discussed previously.

In the Partial Data Transfer Scenario, collected data is only partially transferred for processing. DIMS then outputs only a portion of the data requested and notifies the operator that available data cannot cover the period specified. By the user's choice, DIMS may then prompt whether they would like to see a projection of the available data into the future based on prior data collected, and machine learning and/or AI analysis aided by reinforcement learning. If the user selects yes, the user may further specify whether they would like the projection to be based on the Happy Path or other simulated scenarios. Unavailable data may be stored locally and integrated into DIMS when all normal system functions are restored, pursuant to a future self-diagnosis by DIMS.

In the No Data Transfer Scenario, no data is transferred at all due to some error. In this scenario, data is stored in a backup location. Self-diagnosis by DIMS may reveal the specific system component in question which has stopped transmission, and further provide notifications to users as to that cause. This may be accomplished by means including but not limited to, ping and return signal processing (locally by other data acquisition units or from the main server), or abnormal data loss or error over a threshold period. The user may then choose to see continued projections of future data based on the Happy Path or other simulated scenarios, for which DIMS will assume the functioning link was still in place. DIMS may notify the user that the unavailable data is stored locally and will be integrated into DIMS when all normal functions are restored, pursuant to a future self-diagnosis by DIMS.

In the Inability to Process Collected Data Scenario, data has been collected and sent but is otherwise unavailable to be processed for a variety of reasons (such as subsystem attack, maintenance, data transmission outages, 3^{rd} party issues, satellite errors, etc.). In this scenario, data is stored in a backup location. Self-diagnosis by DIMS may reveal the specific reason by which data has been made unavailable for processing. In this scenario, the user may receive information on how long an asset may continue functioning without the need for replacement, but the user will be informed that no further data processing may be performed. DIMS then proposes to schedule a maintenance window with the assistance of user inputs.

In the Scheduled Maintenance Scenario, maintenance to DIMS is being undergone. The user may receive the choice of modifying the maintenance session. The user receives a notification when the scheduled maintenance session is completed but otherwise is unable to access the software.

In the Unscheduled Maintenance Scenario, DIMS runs a self-diagnosis, which reveals that a component of the system which was previously operating has been damaged or otherwise made compromised. A notification may be sent to the user identifying the damaged component, and that the component must be replaced for normal operations to continue. DIMS may then automatically schedule a maintenance session or allow for the user to do so manually. Maintenance personnel are also notified as to the location, nature, or any other details surrounding the compromised component.

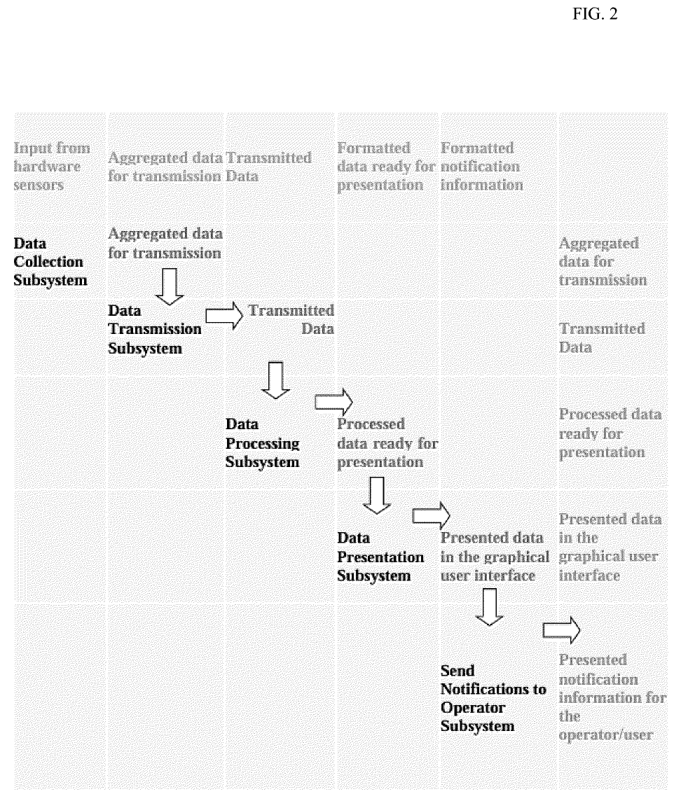

FIG. 2 is a system map of one embodiment of the system, in terms of inputs and outputs. The system is intended to continuously collect, process, transmit, present, and notify users of data, while also allowing users to monitor incoming data via the data visualization subsystem independently.

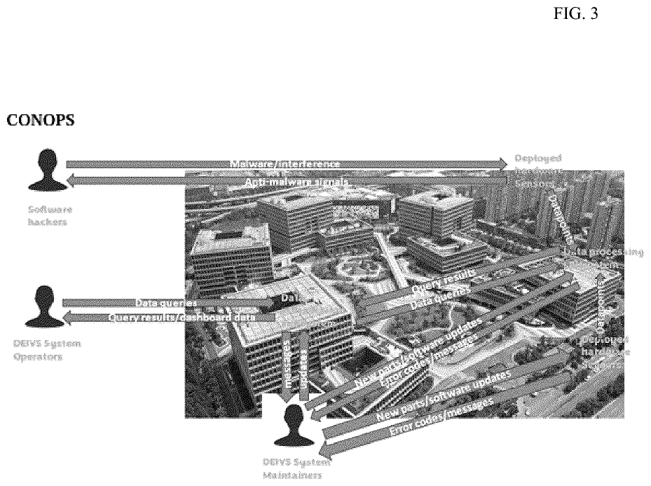

FIG. 3 is an aerial view of one embodiment of the system, which shows the connections between the core functions in physical space. Data is transmitted along the depicted arrows, between hardware and software. At least three external actors are present within the system: DIMS operators and maintainers (users), and hackers. Attacks which are capable of being defended by the system include but are not limited to: denial-of-service, man-in-the-middle, spoofing, and jamming attacks. Embodiments of the system which defend against common hacking attempts will be discussed below.

In defending against denial-of-service attacks, the use of web application firewalls may be used to block malicious traffic targeting a user that signs up to view the data provided by DIMS through a web client. DIMS may also use load balancers programmed with specific rules to route suspicious web clients to a quarantined section of the internet. Alternatively, content delivery networks may route suspicious IP addresses to static webpages with ‘page not found’ content. Machine learning and/or AI models within DIMS may be trained on pattern recognition, adaptive thresholds, common attack vectors, predictive models, anomaly detection and other methods to improve efficiency. The machine learning and/or AI processing of DIMS works in conjunction with all other data acquisition units, improving defense as more devices are connected and processed by DIMS.

In defending against man-in-the-middle attacks, data encryption algorithms such as Diffie-Helman, RSA, and secure shell (ssh) are implemented in software such as 7-zip and Vaultree. Secure VPN tunnels and cloud service providers may also be used. Authentication schemes, such as the use of public key infrastructure, certificates from trusted certificate authorities, and multifactor authentication may be used within DIMS. Regular penetration testing is used to identify common vulnerabilities and exploits, and results may be further used to train AI and/or machine learning models.

In defending against spoofing attacks, best practices are utilized such as: firewalls, domain name system security, network segmentation, intrusion detection, and intrusion protection systems. The latter of which may be used in conjunction with machine learning and/or AI, to improve detection and protection efficiency by analyzing behavior of data acquisition units in the process of attack.

In defending against jamming attacks, techniques such as IP address hopping, encryption, network segmentation, and incident response planning (e.g., hopping to a redundant network, changing a machine's IP address, etc.) may be utilized. With regards to encryption, the hardware data acquisition units in the field may encrypt data as it is being transmitted. AI and/or machine learning may also be used to determine the appropriate level and type of encryption to balance protection of the system with efficiency. This may be accomplished through real-time monitoring of system load and potential security threats, followed by adaptive encryption that optimizes the balance between security and efficiency.

In defending against other miscellaneous attacks, general defense measures may further include data masking of the information at rest within components of the system, zero-trust architecture, dynamic data tokenization for connecting devices to the system, redundancy/fault tolerance to ensure functionality even when specific components are compromised, and geofencing/location-based access controls to ensure that system components are in their correct locations and data transmission occurs only within the desired range.

1. A data management system comprising:
data acquisition units, wherein each data acquisition unit is connected to a central processing subsystem, configured to analyze and transmit data to a visualization subsystem user interface;
one or more AI or machine learning models, wherein the AI or machine learning model(s) are configured to:
predict timelines of longevity for continued asset function,
predict future measurements from the data acquisition units, interpolate missing data, notify relevant parties of data management issues, and diagnose issues in the data management system at all points of data acquisition, processing, transmission, and presentation,
protect data security through automated responses that are reinforced through machine learning of common hacking attempts,
transform the data into optimized formats for presentation,
analyze transmitted signals against background noise,
perform secondary calculations and statistical analytics, and
filter, sort, or generate visual dashboards or reports;
wherein the system includes a notification subsystem configured to generate and send to users automated notifications that are adjustable based on user-defined preferences, including system diagnostics, predictive maintenance alerts, or other analytics.

2. The system of claim 1, wherein data interpolation or extrapolation compares predicted measurements to locally stored values in the data acquisition unit(s) following data transmission outages.

3. The system of claim 1, wherein a self-diagnosis result will trigger an alternate protocol of operation for the data management system, or trigger maintenance operations for scheduled/unscheduled maintenance scenarios.

4. The system of claim 1, wherein the system's malware defense further comprises web application firewalls, rerouting, pattern recognition, adaptive thresholds, predictive models, anomaly detection, data encryption algorithms, secure VPN tunnels, cloud service providers, authentication schemes, firewalls, domain name system security, network segmentation, and intrusion detection and intrusion protection system, IP address hopping, and intrusion detection and protection facilitated by machine learning.

5. The system of claim 1, wherein data transmission includes the functions of aggregation, compression, encryption, packetization and segmentation, routing and switching, flow control techniques such as buffering, windowing, and congestion avoidance algorithms, error correction techniques, and data security measures.

6. The system of claim 1, wherein the notification subsystem is configured to send alert notifications to operators, users, or maintenance personnel across multiple devices, the notifications comprising an explanation of any actual or potential issue, a proposed maintenance schedule, an option to modify or reject the proposed maintenance, and a follow-up notification upon successful resolution.

7. The system of claim 1, wherein data acquisition, transmission, processing, and presentation each includes the functions of data encryption and decryption, verification, validation, transformation into a readable format, central indexing, and backup storage in the event of a central processing subsystem failure.

8. The system of claim 1, wherein the system's data security protection includes AI/machine learning-driven encryption, which continuously optimizes the balance between resource efficiency and security.
